(19) United States
(12) Patent Application Publication
(10) Pub. No.: US 2026/0051541 A1
(43) Pub. Date: Feb. 19, 2026

(54) ELECTROLYTE SOLUTION COMPOSITION FOR SECONDARY BATTERY AND SECONDARY BATTERY COMPRISING THE SAME

(71) Applicant: ZF Solution Co. Ltd., Gyeonggi-do (KR)

(72) Inventors: JAE YUN RHO, Gyeonggi-do (KR); JEONG WOOK LEE, Gyeonggi-do (KR)

(21) Appl. No.: 18/814,788

(22) Filed: Aug. 26, 2024

(30) Foreign Application Priority Data
Aug. 16, 2024 (KR) 10-2024-0109769

(51) Int. Cl. H01M 10/0569; H01M 10/0568

(52) U.S. Cl. CPC H01M 10/0569; H01M 10/0568; H01M 2300/0037; H01M 2300/0051

(57) ABSTRACT

The present invention relates to an electrolyte solution composition for a secondary battery and a secondary battery comprising the same, which, by including an amphiphilic solvent and a lithium salt electrolyte, reduces fire risks and facilitates temperature management of the battery.

### CROSS-REFERENCE TO RELATED APPLICATION AND CLAIM OF PRIORITY

This application claims the benefit under 35 USC § 119 of Korean Patent Application No. 10-2024-0109769, filed on Aug. 16, 2024, in the Korean Intellectual Property Office, the entire disclosure of which is incorporated herein by reference for all purposes.

### BACKGROUND

### 1. Technical Field

The present invention relates to an electrolyte solution composition for a secondary battery and a secondary battery comprising the same.

### 2. Background Art

The electrolyte solution of a secondary battery generally consists of various types of lithium salts (typically lithium hexafluorophosphate, LiPF6) and solvents. The solvents used are those with high solubility for lithium salts, high dielectric constants, and high flash points. Ethylene carbonate (EC) typically serves this role. However, despite its excellent solvent properties, EC exists as a solid at room temperature and has high viscosity, requiring it to be mixed with other solvents (low viscosity materials).

The components of the electrolyte solution in secondary batteries are primarily composed of materials with low boiling points or flash points, which can easily lead to thermal runaway during temporary temperature increases or impacts. This fire hazard exists during charging or during transport, posing a significant flaw in the safety of electric vehicles. Moreover, as the use of secondary batteries expands beyond electric vehicles to various fields like robots, fire incidents causing human injury and property damage are increasing. These fire hazards and possibilities present a major obstacle to the technical development of secondary batteries and their application products.

Currently, the technical elements of secondary batteries are divided into performance factors such as charging speed, discharging speed, and charging capacity, and safety factors such as fire potential and overheating. Performance-related factors are critical as they determine the driving range and charging time of electric vehicles. However, safety issues like fire hazards and the difficulty of extinguishing fires pose the greatest psychological barrier to consumers for the expansion of the electric vehicle market. The solvent components in the electrolyte solution are the primary contributors to these safety threats.

For lithium ions and other cations to freely move between the anode and cathode through the separator in the electrolyte solution, the solvent must have high solubility for the electrolyte and low viscosity. Thus, the electrolyte solvent is a mixture to satisfy the physicochemical properties required by the secondary battery. Ethylene carbonate (EC) has high solubility for lithium salts, with a boiling point (B.P.) of 243° C. and a flash point (F.P.) of 150° C., indicating excellent thermal stability. However, since its melting point (M.P.) is 34° C., it exists as a solid at room temperature, making it unsuitable for use as a single solvent. Therefore, it is typically used in combination with other solvents that can remain in a liquid state when mixed with EC.

The fire risk of existing electrolyte solutions stems from the additional organic solvents such as dimethyl carbonate (DMC), ethyl methyl carbonate (EMC), and diethyl carbonate (DEC). These materials improve the low viscosity and low freezing point characteristics of EC while maintaining its high lithium salt solubility and high dielectric constant advantages. Consequently, these solvents are mixed with EC in various proportions to be used as electrolyte solutions. However, these materials have low flash points or boiling points, making them easily flammable. Concerns about battery or electric vehicle fires, such as intense flames upon ignition and the difficulty of extinguishing fires, are attributed to the flammable/volatile properties of these co-solvents. These solvents do not dissolve well in water or traditional extinguishing agents, posing a challenge in extinguishing fires in secondary batteries.

When using electrolyte solutions with low flash points, the battery system requires a stringent Battery Management System (BMS) to prevent temperatures from rising above the flash point during charging and discharging. If a solvent with a sufficiently high flash point is used in the electrolyte solution, the system can operate more flexibly over a broader temperature range.

### SUMMARY

It is an object of the present invention to provide an electrolyte solution composition for a secondary battery that reduces fire risks and facilitates temperature management of the battery.

It is also an object of the present invention to provide a secondary battery comprising the aforementioned electrolyte solution composition.
1. An electrolyte solution composition for a secondary battery comprising an amphiphilic solvent and a lithium salt electrolyte.
2. The electrolyte solution composition for a secondary battery according to item 1, wherein the amphiphilic solvent is ethyl 3-hydroxypropanoate or methyl 3-hydroxypropanoate.
3. The electrolyte solution composition for a secondary battery according to item 2, further comprising ethylene carbonate.
4. The electrolyte solution composition for a secondary battery according to item 3, wherein the ethyl 3-hydroxypropanoate or methyl 3-hydroxypropanoate and ethylene carbonate are included in a volume ratio of 1:0.5 to 2.
5. A secondary battery comprising a cathode, an anode, a separator positioned between the cathode and anode, and the electrolyte solution according to item 1.

The electrolyte composition of the present invention can suppress ignition and fire growth in secondary batteries by reducing the vapor pressure of the electrolyte while significantly increasing the flash point as a non-flammable material.

The electrolyte composition of the present invention, and the secondary battery containing the same, can suppress ignition and fire growth.

Despite the fire suppression effects, the electrolyte solvent composition that can serve as fuel in the event of a fire is composed of eco-friendly amphiphilic solvents that are well soluble in water, making it easy to dissolve and extinguish with water.

In battery systems employing the electrolyte composition and secondary battery of the present invention, the flash point is much higher than the flammable standard of 93° C. set by the US OSHA fire standards, allowing operation at much higher temperatures, safety during temporary shocks, and maintenance of battery condition.

### BRIEF DESCRIPTION OF THE DRAWINGS

FIG. 1 Shows the electrical conductivity results after dissolving lithium hexafluorophosphate (LiPF₆) in EHP from 0.5M to 3M.

FIG. 2 Shows the electrical conductivity results after dissolving lithium hexafluorophosphate (LiPF₆) in a mixed solvent of EHP and ethylene carbonate (EC) in a 1:1 ratio from 0.5M to 3M.

FIG. 3 Shows the electrical conductivity results of two existing lithium-ion electrolytes (electrolyte I, II) and the EHP/EC electrolyte over a wide temperature range.

### DETAILED DESCRIPTION

The present invention will now be described in detail.

The present invention relates to an electrolyte composition for secondary batteries.

The electrolyte composition of the present invention includes amphiphilic solvents and electrolytes.

Amphiphilic solvents have both hydrophobic and hydrophilic properties, allowing them to dissolve both hydrophobic and hydrophilic substances.

Typically, solvents used in secondary battery electrolytes include ethylene carbonate (which is solid at room temperature) and solvents that can dissolve it, such as dimethyl carbonate (DMC), ethyl methyl carbonate (EMC), and diethyl carbonate (DEC). However, these solvents have low flash points or boiling points, making them easily flammable and exacerbating fires when they occur. However, the electrolyte composition of the present invention uses amphiphilic solvents to prevent these issues.

Amphiphilic solvents may include ethyl 3-hydroxypropanoate (C₅H₁₀O₃, EHP) or methyl 3-hydroxypropanoate (C₄H₈O₃, MHP). These solvents may be non-volatile or non-flammable.

The composition of the present invention may further include ethylene carbonate, which can be used as a solvent together with the amphiphilic solvent.

The mixture ratio of the amphiphilic solvent and ethylene carbonate is not specifically limited and may be included in a volume ratio of 1:0.5 to 2.

The electrolyte may be any commonly used electrolyte in secondary batteries. For example, the electrolyte may be a lithium salt. The lithium salt serves as a medium for ion transfer, including lithium cations (Li⁺), and may include one or more anions selected from the group consisting of F⁻, Cl⁻, Br⁻, I⁻, NO₃⁻, N(CN)₂⁻, ClO₄⁻, BF₄⁻, AlO₄⁻, AlCl₄⁻, PF₆⁻, SbF₆⁻, AsF₆⁻, BF₂C₂O₄⁻, BC₄O₈⁻, (CF₃)PF₄⁻, (CF₃)₃PF₃⁻, (CF₃)₄PF₂⁻, (CF₃)₅PF⁻, (CF₃)₆P⁻, CF₃SO₃⁻, C₄F₉SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SFs)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, but is not limited thereto.

The lithium salt may be included at a concentration of, for example, 0.1 to 3M.

The present invention also relates to a secondary battery comprising the above electrolyte.

The secondary battery of the present invention includes a cathode, an anode, a separator, and the above electrolyte.

The cathode may include a cathode current collector and a cathode active material layer formed on the cathode current collector. Non-limiting examples of the cathode current collector include foils made of aluminum, nickel, or their combinations, and the cathode active material layer may include a cathode active material, binder, conductive material, dispersant, etc., as necessary.

Conventional cathode active materials can be used, such as lithium cobalt oxide (LiCoO₂), spinel-type lithium manganese oxide (LiMn₂O₄), lithium manganese oxide (LiMnO₂), lithium nickel oxide (LiNiO₂), lithium iron phosphate (LiFePO₄), lithium manganese phosphate (LiMnPO₄), lithium cobalt phosphate (LiCoPO₄), lithium iron pyrophosphate (Li₂FeP₂O₇), lithium niobate oxide (LiNbO₂), lithium iron oxide (LiFeO₂), lithium magnesium oxide (LiMgO₂), lithium copper oxide (LiCuO₂), lithium zinc oxide (LiZnO₂), lithium molybdate oxide (LiMoO₂), lithium tantalate oxide (LiTaO₂), lithium tungstate oxide (LiWO₂), over-lithiated lithium manganese nickel cobalt oxide, lithium nickel cobalt aluminum oxide, lithium nickel cobalt manganese oxide, but are not limited thereto.

Conductive materials may include carbon black such as carbon black, acetylene black, Ketjen black, channel black, furnace black, lamp black, thermal black; conductive fibers such as carbon fibers, metal fibers; conductive powders such as fluorinated carbon, aluminum, nickel powders; conductive whiskers such as zinc oxide, potassium titanate whiskers; conductive metal oxides such as titanium oxide; and conductive materials such as polyphenylene derivatives, as long as they do not cause chemical changes in the battery and have conductivity.

Binder polymers may include nitrile butadiene rubber, polybutadiene rubber, polyethylene glycol, polyacrylonitrile, polyvinyl chloride, polymethyl methacrylate, polypropylene oxide, polydimethylsiloxane, polyvinylidene fluoride, polyvinylidene carbonate, polyvinylpyrrolidone, and combinations thereof.

The anode may include an anode current collector and an anode active material layer formed on the anode current collector.

Non-limiting examples of the anode current collector include foils made of copper, gold, nickel, copper alloy, or combinations thereof.

The anode active material layer may include any conventional anode active material, such as soft carbon, hard carbon, artificial graphite, natural graphite, expanded graphite, carbon fiber, non-graphitizable carbon, carbon black, carbon nanotube, acetylene black, Ketjen black, graphene, fullerene, activated carbon, mesocarbon microbeads, and carbon; metals such as silicon, tin, lithium, aluminum, silver, bismuth, indium, germanium, lead, platinum, titanium, zinc, manganese, cadmium, selenium, copper, cobalt, nickel, and iron; alloys containing two or more of these metals; and oxides of one or more of these metals.

The present invention will now be described in more detail with reference to the following embodiments.

### Example

### 1. Measurement of Electrical Conductivity According to Electrolyte Concentration

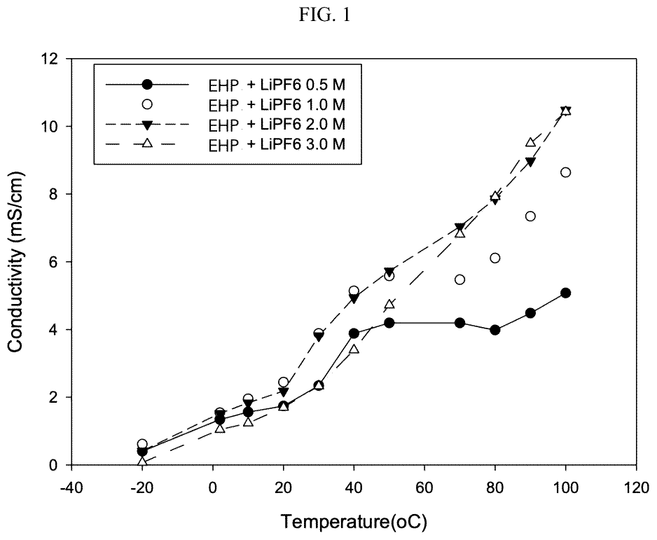

(1) The electrical conductivity of the electrolyte solution was measured by adding lithium hexafluorophosphate (LiPF₆) as an electrolyte to the amphiphilic solvent ethyl 3-hydroxypropanoate at concentrations ranging from 0.5M to 3M. The experiment was conducted using a temperature-controlled device, and the operating temperature ranged from −20 to 100° C. The measurement results are shown in FIG. 1.

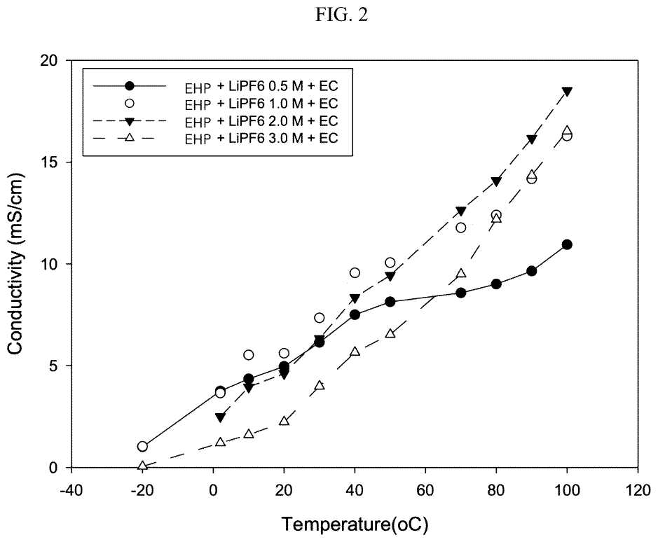

As the temperature increased from low to high, ion movement became more active, showing an increase in electrical conductivity. The electrical conductivity also increased as the concentration of lithium salt increased. The conditions of 1M and 2M lithium salt concentrations showed relatively higher electrical conductivity. Notably, these results demonstrated stable electrical conductivity even at much higher temperature conditions (30 to 100° C.) compared to the flash points (<30° C.) of traditional solvents like DMC and DEC used in existing electrolytes.
(2) The electrical conductivity of the electrolyte solution was measured by adding lithium hexafluorophosphate (LiPF₆) as an electrolyte to a mixed solvent of ethyl 3-hydroxypropanoate and ethylene carbonate in a 1:1 volume ratio at concentrations ranging from 0.5M to 3M. Although ethylene carbonate is a solid at room temperature, it remained stable in liquid form when dissolved in ethyl 3-hydroxypropanoate, maintaining its liquid state even at −20° C., showing the potential to replace traditional volatile solvents. The measurement results are shown in FIG. 2.

Similarly, it exhibited high electrical conductivity even up to 100° C. This aligns with existing research results that the addition of EC is crucial for electrical conductivity. Both EHP and EC have high boiling and flash points, making them very advantageous electrolyte solvents in terms of thermal stability and fire resistance.

2. Comparison of Electrical Conductivity with Existing Electrolytes Across Different Temperatures

The electrical conductivity of two types of existing lithium-ion electrolytes (electrolyte I, II) and the EHP/EC electrolyte was measured over a wide temperature range. The concentration of lithium hexafluorophosphate (LiPF₆) was fixed at 1M, and the temperature range was-20 to 100° C. The existing commercial electrolyte components were as follows:
Electrolyte I: 1M LiPF₆ in EC:DEC=1:1 (v/v) (LiPF₆ dissolved at a concentration of 1M in a 1:1 volume solution of EC and DEC)
Electrolyte II: 1M LiPF₆ in EC:DEC:EMC=1:1:1 (v/v) (LiPF₆ dissolved at a concentration of 1M in a 1:1:1 volume solution of EC, DEC, and EMC)

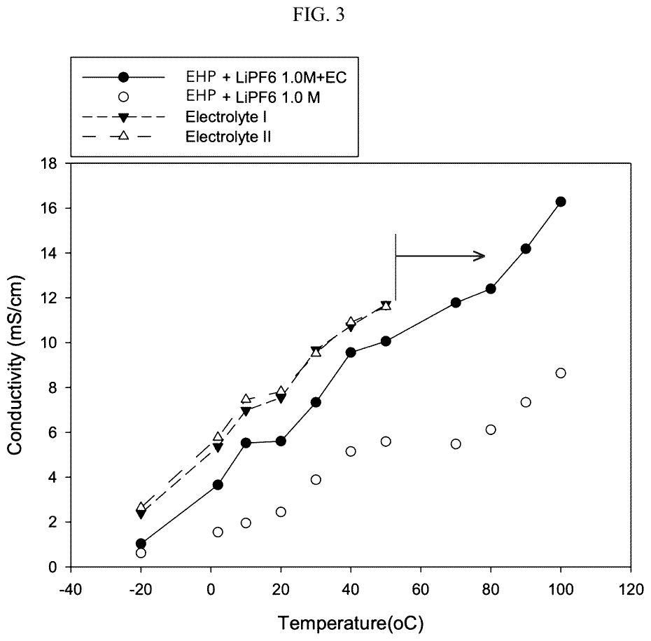

The measurement results are shown in FIG. 3.

The two types of existing electrolytes could only be operated up to 40° C. due to their high flammability. While the existing electrolytes had slightly higher conductivity up to 40° C., their stability decreased at higher temperatures, preventing further experiments. In contrast, the EHP+EC or EHP alone proposed in this invention could be measured at high temperatures. For reference, the flash points of each solvent are shown in Table 1 below.

TABLE 1

| Solvent | Flash point(° C.) - Closed cup |
|---|---|
| EHP | 112 |
| EC | 150 |
| EHP:EC = 1:1 | 124 |
| EHP:EC = 2:1 | 117 |
| EHP:EC = 1:2 | 139 |
| MHP | 78 |

### 3. Comparison of Electrical Conductivity According to Solvent

The electrical conductivity was measured according to temperature by mixing ethylene carbonate with methyl 3-hydroxypropanoate or ethyl 3-hydroxypropanoate. The results are shown in Table 2 below.

TABLE 2

Electrical conductivity (mS/cm)

| Temperature | MHP:EC = | EHP + EC = |
|---|---|---|
| (° C.) | 1:1 | 1:1 |
| 2 | 5.14 | 4.06 |
| 10 | 7.11 | 6.53 |
| 20 | 8.49 | 7.27 |
| 30 | 10.48 | 8.87 |
| 40 | 11.57 | 10.37 |
| 50 | 15.18 | 12.02 |
| 60 | 17.16 | 14.87 |
| 70 | 18.79 | 16.23 |
| 80 | 16.30 | 18.17 |
| 90 | 10.69 | 19.11 |
| 100 | — | 19.56 |

It can be seen that MHP exhibits approximately 20% higher electrical conductivity within a certain temperature range compared to EHP. This is likely because MHP has a lower molecular weight than EHP, resulting in lower viscosity, which is advantageous for ion mobility. However, unlike EHP, the MHP+EC combination showed a decrease in electrical conductivity above 90° C., indicating that the thermal stability at high temperatures is somewhat lower than that of EHP.

What is claimed is:

1. An electrolyte solution composition for a secondary battery comprising an amphiphilic solvent and a lithium salt electrolyte.

2. The electrolyte solution composition for a secondary battery according to claim 1, wherein the amphiphilic solvent is ethyl 3-hydroxypropanoate or methyl 3-hydroxypropanoate.

3. The electrolyte solution composition for a secondary battery according to claim 2, further comprising ethylene carbonate.

4. The electrolyte solution composition for a secondary battery according to claim 3, wherein the ethyl 3-hydroxypropanoate or methyl 3-hydroxypropanoate and ethylene carbonate are included in a weight ratio of 1:0.5 to 2.

5. A secondary battery comprising a cathode, an anode, a separator positioned between the cathode and anode, and the electrolyte solution according to claim 1.
